(19) United States
(12) Patent Application Publication
(10) Pub. No.: US 2025/0037036 A1
(43) Pub. Date: Jan. 30, 2025

(54) SUPERVISED AND MULTIVARIATE CONTINUOUS ATTRIBUTES DISCRETIZATION

(71) Applicant: SAP SE, Walldorf (DE)

(72) Inventor: Louis Desreumaux, Levallois Perret (FR)

(21) Appl. No.: 18/358,452

(22) Filed: Jul. 25, 2023

(51) Int. Cl. G06N 20/20

(52) U.S. Cl. CPC G06N 20/20

(57) ABSTRACT

In an implementation, a computer-implemented method includes receiving a plurality of inputs corresponding to a plurality of instances, where each input of the plurality of inputs representing multiple attributes of a respective instance. The computer-implemented method further includes training, using the plurality of inputs and as a trained supervised and multivariate machine learning model, a supervised and multivariate machine learning model. The computer-implemented method further includes determining multiple split point lists based on the trained supervised and multivariate machine learning model, where the multiple split point lists correspond to the multiple attributes, and where each of the multiple split point lists includes a number of split points and a number of split gains associated with a respective attribute.

### BACKGROUND

Discretization refers to a process of converting continuous attributes or features to discretized data sets. Supervised discretization is used to preprocess raw input data in many knowledge discovery and data mining tasks. Using the discretized data sets as inputs, these tasks may produce better results due to a reduced computational load. An objective of the supervised discretization is to induce a list of intervals which partition a numerical domain of each continuous attribute. When continuous attributes are discretized, there may be some discretization errors or information loss. During the supervised discretization, it is desired to reduce the information loss and find a trade-off between information quality and statistical quality.

### SUMMARY

The present disclosure describes supervised and multivariate continuous attributes discretization.

In an implementation, a computer-implemented method includes receiving a plurality of inputs corresponding to a plurality of instances, where each input of the plurality of inputs representing multiple attributes of a respective instance. The computer-implemented method further includes training, using the plurality of inputs and as a trained supervised and multivariate machine learning model, a supervised and multivariate machine learning model. The computer-implemented method further includes determining multiple split point lists based on the trained supervised and multivariate machine learning model, where the multiple split point lists correspond to the multiple attributes, and where each of the multiple split point lists includes a number of split points and a number of split gains associated with a respective attribute. The computer-implemented method further includes for each attribute of the multiple attributes, determining a cut point list by clustering the split point list associated with the attribute based on the number of split points and the number of split gains comprised in the split point list, where the cut point list includes a number of cut points dividing the attribute into one or more intervals. The computer-implemented method further includes dividing the plurality of instances into one or more groups based on the plurality of inputs and the one or more intervals.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the proposed supervised and multivariate attributes discretization methods take advantage of advanced machine learning models (such as a tree-based machine learning model) to reduce sizes of multivariate discretization models so that the methods can be implemented to obtain good solutions within a practical computation time. Second, the proposed methods can obtain a balance between the optimization quality and the computation time. Third, the proposed methods take advantage of the importance metric associated with split points and build a reduced set of cut points.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIGS. 1A-1B are graphs that illustrate an example XOR pattern, according to an implementation of the present disclosure.

FIG. 2 illustrates a class conditional density histogram for an age attribute used in a prediction task, according to an implementation of the present disclosure.

FIG. 3 is a flowchart illustrating an example of a computer-implemented method for supervised and multivariate continuous attributes discretization, according to an implementation of the present disclosure.

FIG. 4 illustrates an example of a trained Gradient Tree Boosting (GTB) model, according to an implementation of the present disclosure.

FIG. 5A is a flowchart illustrating an example of a computer-implemented method for determining a cut point list, according to an implementation of the present disclosure.

FIG. 5B is a flowchart illustrating an example of a weighted k-medians clustering algorithm, according to an implementation of the present disclosure.

FIGS. 6A-6I illustrate an example of a supervised and multivariate attributes discretization method, according to an implementation of the present disclosure.

FIG. 7 illustrates another example of a supervised and multivariate attributes discretization method, according to an implementation of the present disclosure.

FIG. 8 illustrates a data analysis example using supervised discretization, according to an implementation of the present disclosure.

FIG. 9 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes supervised and multivariate continuous attributes discretization, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Discretization refers to a process of converting continuous attributes or features to discretized data sets. Assuming a dataset of n instances and p continuous descriptive attributes including attribute A, a discretization algorithm would discretize attribute A in this dataset into m consecutive and non-overlapping intervals:

$$D = \{ [ {c}_{0} , {c}_{1} ] , ( {c}_{1} , {c}_{2} ] , … , ( {c}_{m - 1} , {c}_{m} ] \} ,$$

where c₀ is the minimal value, cₘ is the maximal value and cᵢ<cᵢ₊₁ for i=0, 1, . . . , m−1. D is called a discretization of attribute A and C={c₁, c₂, . . . , cₘ₋₁} is a set of cut points of attribute A.

Supervised discretization is used to preprocess raw input data in many knowledge discovery and data mining tasks. Using the discretized data sets as inputs, these tasks may produce better results due to a reduced computational load. An objective of the supervised discretization is to induce a list of intervals which partition a numerical domain of each continuous attribute or input variable, while keeping the information relative to output variables of the supervised discretization. When continuous attributes are discretized, there may be some discretization errors or information loss. During the supervised discretization, it is desired to reduce the information loss and find a trade-off between information quality and statistical quality. The information quality may relate to homogeneous intervals regarding the output variables, and the statistical quality may require sufficient sample size in every interval to ensure generalization.

Supervised discretization methods usually perform univariate partitioning. That is, they discretize attributes one at a time. This univariate limitation may prevent them from detecting constructive interactions between variables because input variables might be uninformative when considered alone but strongly informative when considered together simultaneously.

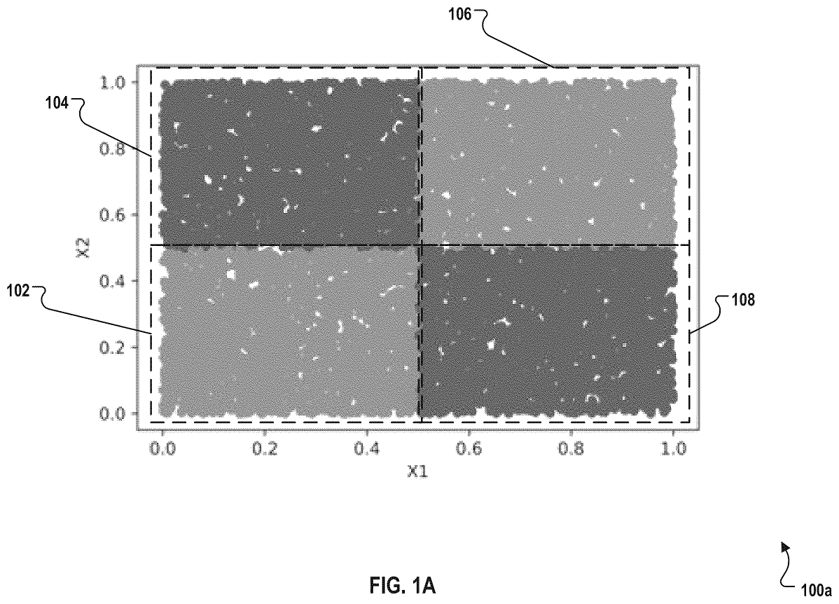

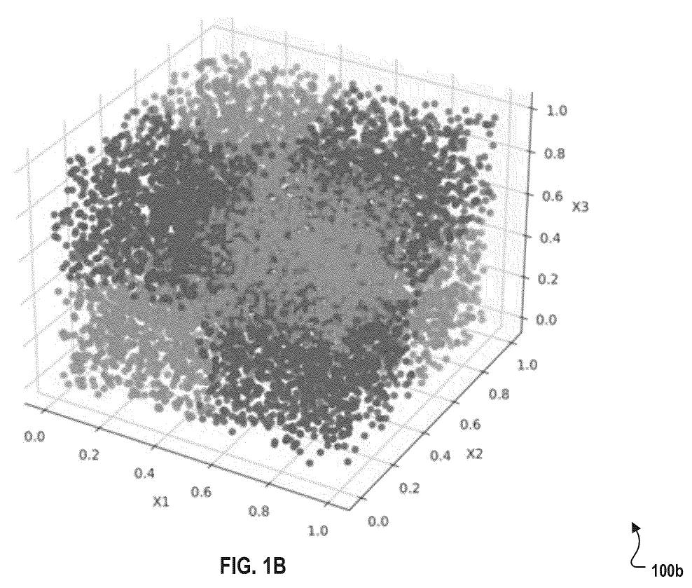

FIGS. 1A-1B are graphs 100a-100b that illustrate an example XOR pattern, according to an implementation of the present disclosure. Graph 100a in FIG. 1A shows two input variables X1 and X2 uniformly distributed on a [0, 1] numerical domain. For each input variable, a Boolean index (also referred to as an input index) is computed according to whether the input variable is smaller or larger than 0.5. An output value is the XOR operation of X1's input index and X2's input index. In other words, the output value is assigned a Boolean value related to a parity of a sum of the input indexes of X1 and X2. The XOR pattern in graph 100a, which illustrates a relationship between the input variables and the output value, is easy to tell when both input variables are considered simultaneously (multivariate methods). For example, an X1 smaller than 0.5 and an X2 smaller than 0.5 correspond to an output value of False (102), and an X1 smaller than 0.5 and an X2 larger than 0.5 correspond to an output value of True (104). In contrast, when only one input variable is considered using the univariate methods, the XOR pattern in graph 100a cannot be detected. For example, an X1 smaller than 0.5 corresponds to both False output (102) and True output (104). Similarly, an X1 larger than 0.5 also corresponds to both False output (106) and True output (108). As such, the input variable X1 (whether smaller than 0.5 or not) may relate to both True and False output values, which is an uninformative observation. Therefore, multivariate methods generate informative results in this case, while univariate methods cannot.

Graph 100b in FIG. 1B shows another XOR pattern with three input variables X1, X2, and X3. Similar to FIG. 1A, the XOR pattern shown in graph 100b cannot be detected by univariate methods since the univariate methods merely consider an individual input variable. In contrast, multivariate methods simultaneously take into consideration all three input variables during their processing, and thus can discriminate the output values in graph 100b based on the input variables.

Supervised discretization is commonly introduced as a data preparation technique (also called a preprocessing step) for some machine learning algorithms that only handle categorical features, such as Naive Bayes classifiers. Some other modern machine learning algorithms, such as Random Forest or Gradient Tree Boosting (GTB), may not require the preprocessing step. Yet, as a complement to sophisticated predictive modeling techniques, supervised discretization can still be useful for understanding and visualizing data.

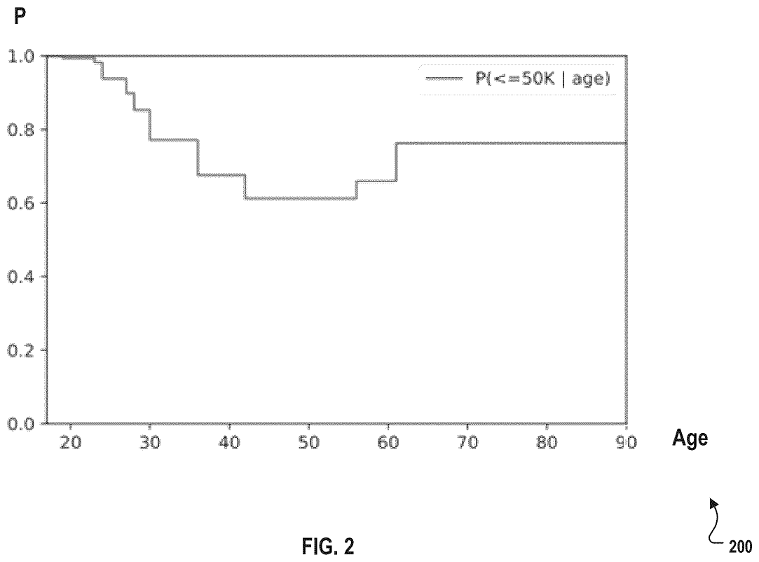

FIG. 2 illustrates a class conditional density histogram 200 for an age attribute used in a prediction task, according to an implementation of the present disclosure. An example prediction task could be to determine a probability that a person's income exceeds $50 k per year, and may consider multiple attributes including the person's age. Histogram 200 in FIG. 2 is generated based on a univariate discretization, and highlights the following observations. When a person's age is below 25, the probability of that person being among the richest is very low. As the person's age increases (up to 40), this probability increases. The probability then stagnates until the person's age reaches 60 and decreases after retirement of the person.

The present disclosure provides supervised and multivariate continuous attributes discretization methods and systems.

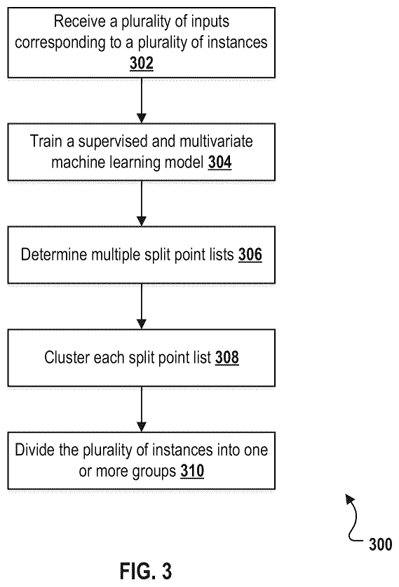

FIG. 3 is a flowchart illustrating an example of a computer-implemented method 300 for supervised and multivariate continuous attributes discretization, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

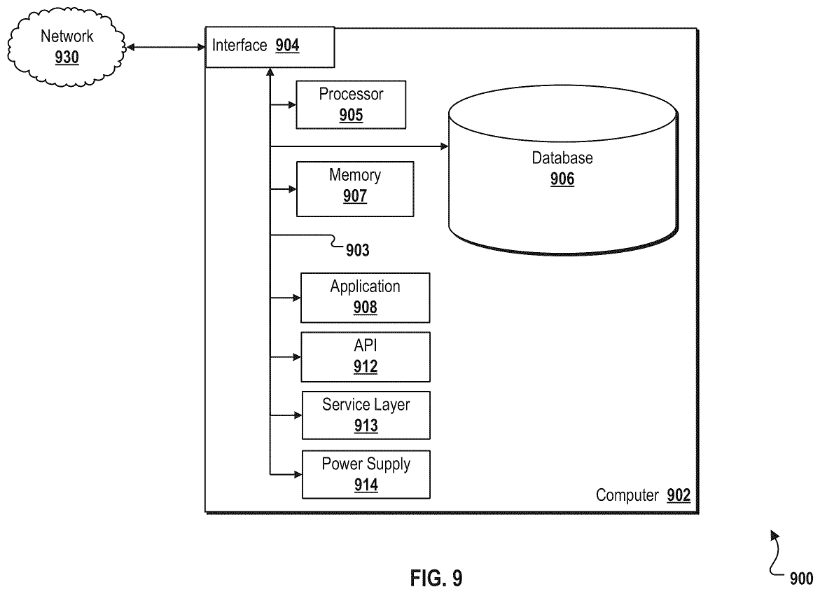

At 302, a system (such as a computer-implemented system subsequently described in relation to FIG. 9) receives a data set. The data set includes a plurality of inputs and a plurality of outputs corresponding to a plurality of instances. For example, the plurality of inputs one-on-one corresponds to the plurality of instances. The plurality of outputs also corresponds one-on-one to the plurality of instances. Each of the plurality of inputs represents multiple attributes of a respective instance. In some implementations, each of the plurality of inputs includes multiple values, and each of the multiple values represents one of the multiple attributes of the respective instance. For example, the plurality of inputs can be represented by vectors of the same length. The length may equal to a quantity of the multiple attributes. From 302, method 300 proceeds to 304.

At 304, the system trains a machine learning model using the plurality of inputs and the plurality of outputs. The objective is to use the trained machine learning model to predict outputs as close as possible to the plurality of outputs based on the plurality of inputs. The machine learning model is a supervised and multivariate model. In some implementations, the machine learning model is a tree ensemble model that uses a sum of multiple additive functions of an input to predict an output. In some implementations, the machine learning model can be a model consistent with and usable with the subject matter as described.

Each of the multiple additive functions corresponds to a decision tree. It may be difficult to enumerate all possible structures for a decision tree. Thus, a greedy algorithm may start from a single leaf of the decision tree and iteratively add branches to the decision tree. The tree ensemble model trained in such a greedy and iterative way is called a Gradient Tree Boosting (GTB) model. Using the GTB model, each of the plurality of inputs may be fed simultaneously into the decision trees, and outputs of the decision trees may be combined to produce a single prediction. In some implementations, the GTB model is flexible in that it can automatically learn non-linear relationships and interaction effects between multiple attributes of the plurality of instances. From 304, method 300 proceeds to 306.

At 306, the system determines multiple split point lists based on the trained supervised and multivariate machine learning model. The system may determine a respective split point list for each of the multiple attributes. A split point list may include a number of split points for a corresponding attribute. The number of split points may serve as candidate thresholds for partitioning the corresponding attribute. In some implementations, if the supervised and multivariate machine learning model is a tree ensemble model, the system may determine the multiple split point lists by traversing each decision tree of the tree ensemble model. During the traversing process, each split point may be associated with a loss reduction, which is also referred to as a gain or a split gain. As such, the number of split points in each split point list may one-on-one correspond to the same number of split gains. In some implementations, each split point list may include both the number of split points and the number of split gains associated with the number of split points. In some implementations, a split point list may be empty if the attribute corresponding to the empty split point list has not been used during training of the tree ensemble model. That is, that attribute is not on any branches of the decision trees of the tree ensemble model. In this case, that attribute may be uninformative and may not be partitioned. In other words, that attribute may be fully compressed into one single interval. In some implementations, one or more split point lists may be empty.

In some implementations, the tree ensemble model may include hundreds of decision trees. A non-empty split list extracted from such a tree ensemble model may include a large number of split points. Using these split points as partitioning thresholds for the corresponding attribute will lead to a large size of a discretization output variable. This may increase the computational complexity of a follow up knowledge discovery or data mining task which uses the discretization output variables as inputs. Thus, method 300 may proceed from 306 to 308 to reduce the size of candidate partitioning thresholds.

At 308, the system determines a cut point list for each attribute of the multiple attributes. The determined cut point list comprises a number of cut points dividing the attribute into one or more intervals. The system may determine the cut point list by clustering the split point list associated with the attribute. Various clustering method may be used depending on the number of split points included in the split point list. From 308, method 300 proceeds to 310.

At 310, the system divides the plurality of instances into one or more groups based on the plurality of inputs and the one or more intervals of each attribute. The one or more intervals of each attribute are determined based a corresponding cut point list at 308.

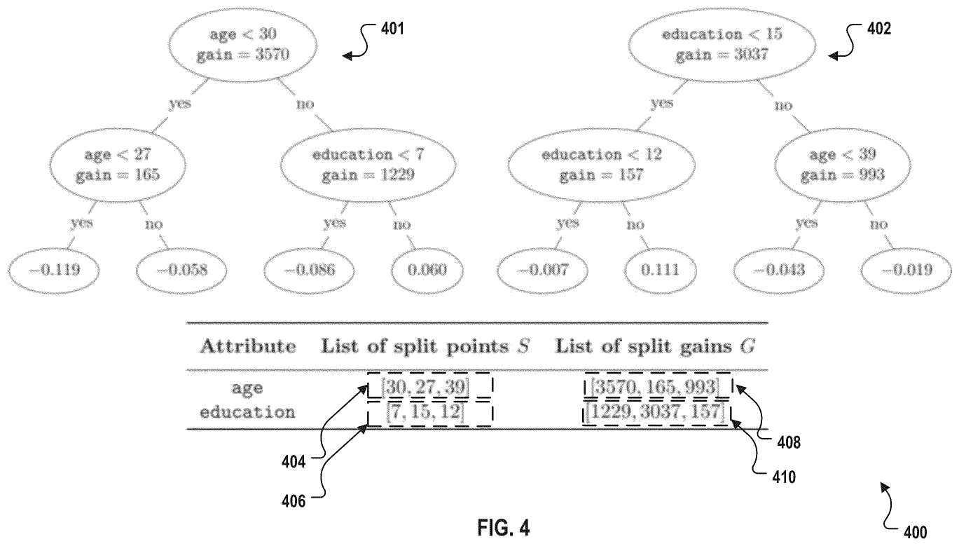

FIG. 4 illustrates an example of a trained GTB model 400 according to an implementation of the present disclosure. GTB model 400 is trained for an income prediction task (which is similar to the example of FIG. 2) with two attributes. The GTB model may be trained at 304 of FIG. 3. As shown in FIG. 4, this GTB model has two attributes “age” and “education.” That is, the purpose of this income prediction task is to determine a probability that a person's income exceeds $50 k per year based on the person's age and education. The trained GTB model has two decision trees 401 and 402. After traversing both decision trees, a split point list 404 for attribute “age” and a split point list 406 for attribute “education” are extracted. Each of split point lists 404 and 406 includes 3 different split points. In addition, split gains 408 and 410, which are associated with split point lists 404 and 406 respectively, are also determined. A sigmoid function is applied to a value associated with a leaf node (for example, the first leaf node on the left represents a value of “−0.119”) to obtain the probability that the person's income exceeds $50 k per year. In this example, there is no empty split point list, which means both attributes “age” and “education” are informative.

Although FIG. 4 illustrates an exemplary trained GTB model with 2 decision trees, this example is not intended to be construed in a limiting sense. Any suitable number of decision trees and any suitable number of empty or non-empty split point lists may be determined during training of a tree ensemble model.

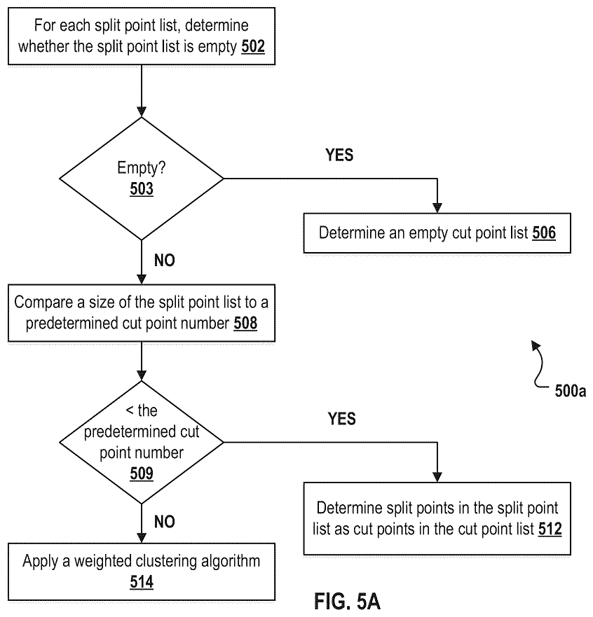

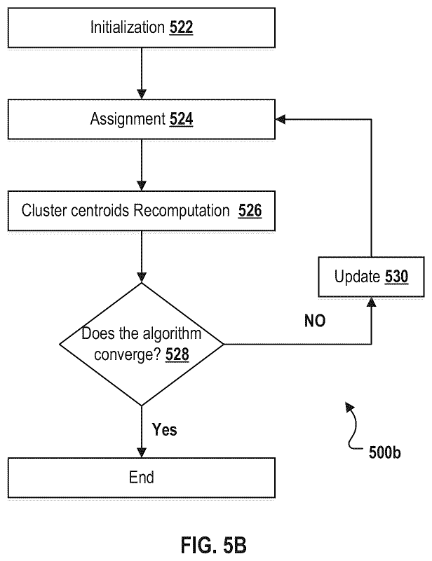

FIG. 5A is a flowchart illustrating an example of a computer-implemented method 500a for determining a cut point list for an attribute, according to an implementation of the present disclosure. For clarity of presentation, the description that follows generally describes method 500a in the context of the other figures in this description. However, it will be understood that method 500a can be performed, for example, by any system, environment, software, and hardware, or a combination of systems, environments, software, and hardware, as appropriate. In some implementations, various steps of method 500a can be run in parallel, in combination, in loops, or in any order. In some implementations, method 500a is performed by a computer-implemented system subsequently described in relation to FIG. 9.

Method 500a may be considered as a detailed example of the previously described step 308 of FIG. 3. Method 500a can be applied to an attribute (such as each of the multiple attributes of the plurality of instances of FIG. 3) and a split point list corresponding to the attribute. The split point list may include a number of split points and a number of split gains associated with the attribute.

At 502, the system determines whether the split point list is empty. From 502, method 500a proceeds to 503.

At 503, if it is determined that the split point list is empty, method 500a proceeds to 506. If the split point list has zero split point and split gain, that means the attribute corresponding to the split point list is not on any branches of the decision trees of the tree ensemble model. The attribute may be considered as uninformative, and thus may not need to be partitioned. In other words, that attribute may be fully compressed into one single interval. Therefore, the system determines an empty cut point list at 506 because no cut point is required to divide the attribute into multiple intervals.

Otherwise, if it is determined that the split point list is not empty, method 500a proceeds to 508.

At 508, the system compares a size of the split point list (referred to as n) to a predetermined cut point number. The predetermined cut point number (referred to as k) is derived from a user-specified number of intervals (k+1) for the attributes, because k cut points can divide the attribute into k+1 intervals. The user-specified number of intervals m may be determined based on the computational complexity requirement of the follow up knowledge discovery or data mining task which uses the discretization output variables as inputs. For example, a larger k may lead to a larger computational complexity for the follow up task to process the discretized attribute. In some implementations, a discretization model with a smaller number of intervals is also preferable if the focus is on interpretability (also referred to as explainability) or data visualization. From 508, method 500a proceeds to 509.

At 509, if it is determined that the size of the split point list is equal to or smaller than the predetermined cut point number k (n≤k), method 500a proceeds to 512. In this case, the attribute is weakly informative. At 512, the system may change the predetermined cut point number from k to the size of the split point list n, and determine a cut point list of size n. The determined cut point list uses all split points in the split point list as its cut points.

Otherwise, if it is determined that the size of the split point list n is larger than the predetermined cut point number k (n>k), method 500a proceeds to 514, where the system applies a weighted clustering algorithm to reduce the n split points. The n split points are input data points of the weighted clustering algorithm, and the k cut points are output data points of the weighted clustering algorithm. The weighted clustering algorithm may use the n split gains as weights that are applied to the split points.

In some implementations, the weighted clustering algorithm is a weighted k-medians clustering algorithm. In some implementations, the weighted clustering algorithm can be some other clustering algorithms.

In some implementations, any suitable clustering algorithm may be applied as long as the algorithm supports weighted input data points and generates output cluster centroids from the input data points. These two properties may help reduce the sensitivity of the algorithm to less important split points, which have smaller split gains (also called loss reductions). An example of such a suitable clustering algorithm is the k-medoids algorithm. In some implementations, clustering algorithms that do not use actual split points as cut points may also be applied.

FIG. 5B is a flowchart illustrating an example of a weighted k-medians clustering algorithm used at 514 of FIG. 5A, according to an implementation of the present disclosure. This example of the weighted k-medians clustering algorithm is referred to as method 500b. In this example, the split point list includes n split points (x₁, . . . , xₙ) and n split gains (w₁, . . . , wₙ). The split points (x₁, . . . , xₙ) are also referred to as data points for method 500b, and the split gains (w₁, . . . , wₙ) are also referred to as weights for method 500b. The predetermined or fixed cut point number is k, which is also referred to as a fixed number of clusters.

At 522, the system performs initialization by randomly selecting k data points from (x₁, . . . , xₙ) as an initial set of cluster centroids (m₁, . . . , mₖ). In some implementations, it is preferable to begin with centroids that are as far from each other as possible because the centroids being too close may impair performance of method 500b. In some implementations, different ways to select the initial cluster centroids can be applied. For example, in a k-means++ algorithm, each data point is selected as a centroid with a probability determined based on a potential function. From 522, method 500b proceeds to 524.

At 524, the system assigns each data point xᵢ (1≤i≤n) to cluster k* based on distance to each of the k centroids (m₁, . . . , mₖ). That is, k*=argminₖ∥xᵢ−mₖ∥². From 524, method 500b proceeds to 526.

At 526, the system recomputes cluster centroids (m₁*, . . . , mₖ*) as the weighted median of the data points belonging to each cluster. From 526, method 500b proceeds to 528.

At 528, the system determines if the recomputed cluster centroids (m₁*, . . . , mₖ*) are the same as the previously determined (m₁, . . . , mₖ). If so, that means method 500b converges, and method 500b ends. If not, method 500b proceeds to 530.

At 530, the system uses the recomputed cluster centroids (m_{1*}, . . . , mₖ*) to update (m₁, . . . , mₖ). Then method 500b repeats 524, 526 and 528 until method 500b converges.

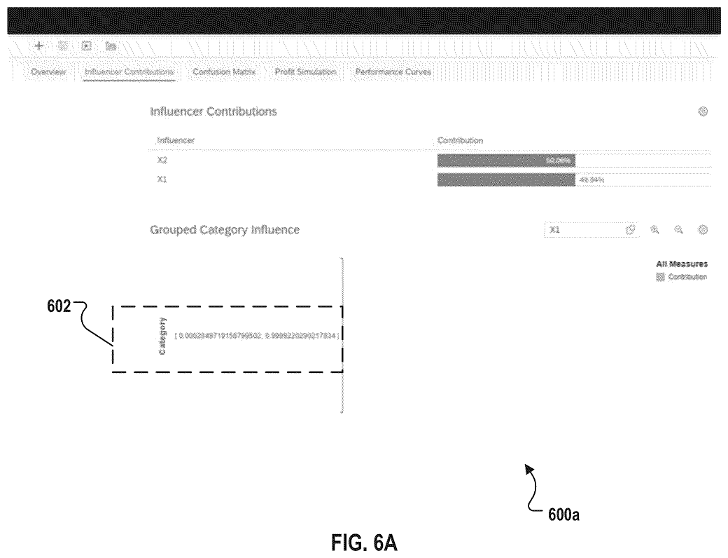

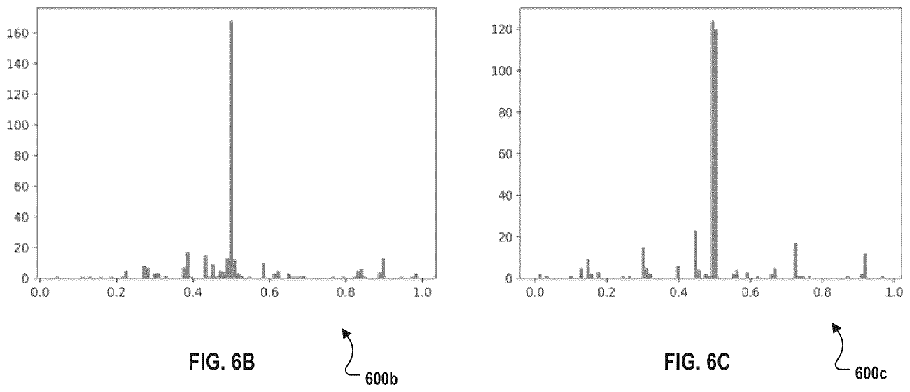

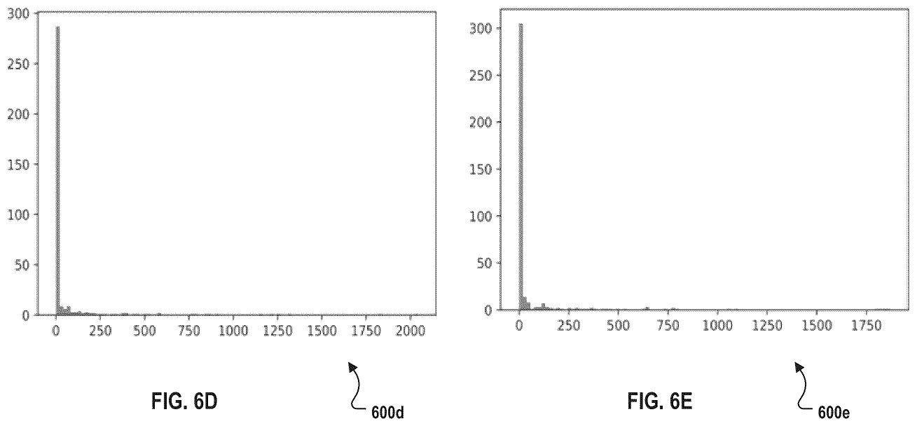

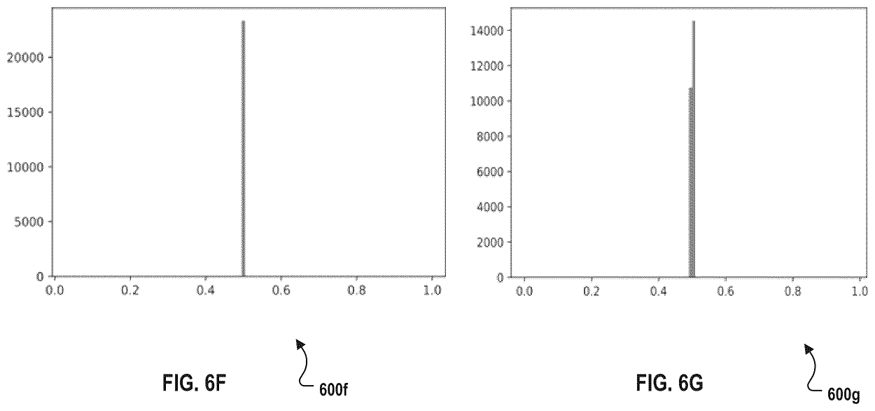

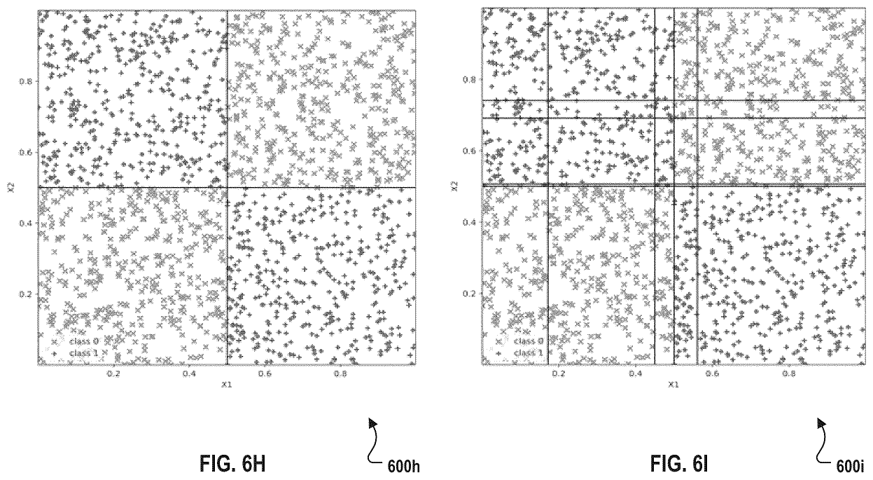

FIGS. 6A-6I illustrate example results of a supervised and multivariate attributes discretization method, according to an implementation of the present disclosure. In this example, both an existing univariate discretization method and a supervised and multivariate discretization method described in this disclosure are applied to the 2-dimensional (2-D) XOR pattern illustrated by graph 100a of FIG. 1A.

FIG. 6A illustrates a graph 600a showing the discretization result generated by a legacy univariate method developed by KXEN. Category 602 in FIG. 6A shows that attribute or input variable X1 is fully compressed into a single interval. In other words, the univariate method cannot detect interactions between attribute X1 and attribute X2.

Next, a supervised and multivariate discretization method that uses a GTB model (such as method 300) is trained on the 2-D XOR pattern. The trained GTB model includes hundreds of split points. Split points for attribute X1 and split points for attribute X2, as well as their corresponding split gains, are extracted from the trained GTB model.

FIG. 6B illustrates a graph 600b showing a distribution of the split points for attribute X1.

FIG. 6C illustrates a graph 600c showing a distribution of the split points for attribute X2.

FIG. 6D illustrates a graph 600d showing a distribution of the split gains for attribute X1.

FIG. 6E illustrates a graph 600e showing a distribution of the split gains for attribute X2. By using the split gains as weights in the k-median algorithm, the supervised and multivariate discretization method may focus on the more important split points.

FIGS. 6F and 6G illustrate a graph 600f and a graph 600g showing weighted distributions of the split gains for attributes X1 and X2 respectively. As shown in FIGS. 6F and 6G, the more important split points are around the value of 0.5 for both attributes X1 and X2.

FIG. 6H illustrates a graph 600h showing the cut points for each attribute and the determined groups by dividing each attribute into multiple intervals based on the cut points when the cut point number is 1. As shown in FIG. 6H, the cut point for each attributed is close to 0.5, which allows a prefect discrimination of the output classes.

FIG. 6I illustrates a graph 600i showing the cut points for each attribute and the determined groups by dividing each attribute into multiple intervals based on the cut points when the cut point number is 4. As shown in FIG. 6I, even though the user-specified cut point number (4) is larger than what is needed, the cut points for each attributed still include a value close to 0.5, and each group contains inputs that all belong to the same output class.

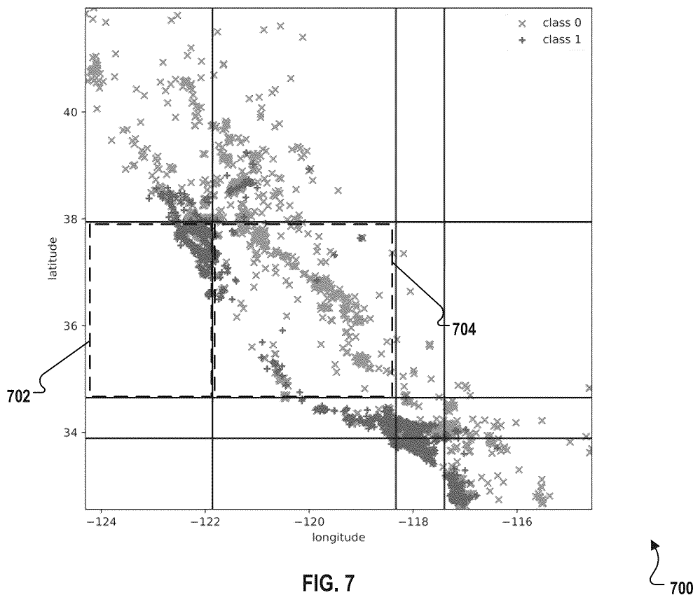

FIG. 7 illustrates example results 700 of another supervised and multivariate attributes discretization method, according to an implementation of the present disclosure. In this example, the supervised and multivariate attributes discretization method is applied to a dataset named “California Housing.” This dataset has two attributes “longitude” and “latitude” representing longitude coordinates and latitude coordinates of a location of a house. A binary output tells if the median house value is high (class 1) or low (class 0). As shown in FIG. 7, when the cut point number is set to 3, the two attributes can be divided into 16 groups. The cut points and the determined groups may be used to generate decision rules to predict whether the median house value is high based on the longitude and latitude of a census block group. For example, if −124.3≤longitude≤−121.860001 and 34.6500015<latitude≤37.9399986 (group 702), then the probability that the median house value is high is 0.74980016. In another example, if −121.860001<longitude≤−118.33002 and 34.6500015<latitude≤37.9399986 (group 704), then the probability that the median house value is high is 0.15111562.

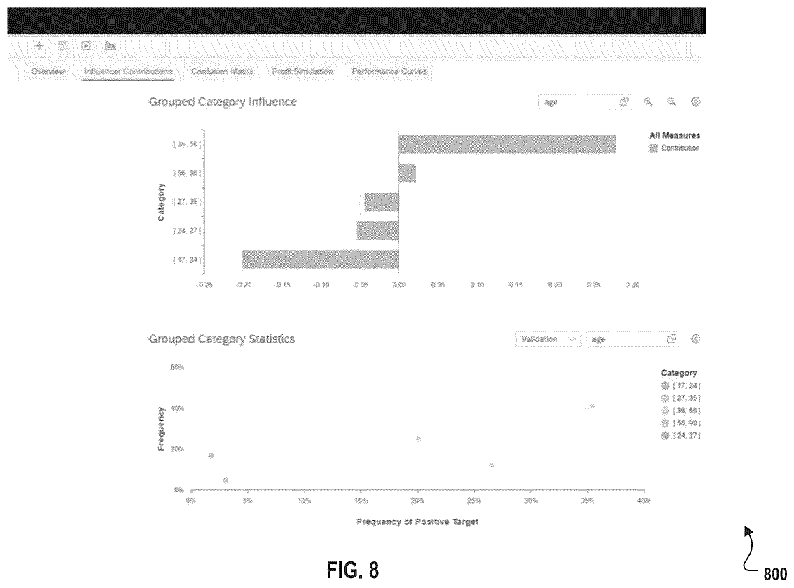

FIG. 8 illustrates a data analysis example 800 using supervised discretization, according to an implementation of the present disclosure. FIG. 8 shows some charts which are built on the discretization of the “age” attribute of a dataset named “Adult.” As shown in FIG. 8, supervised discretization is used to provide a comprehensible analysis of the influence of an attribute on a binary target. The data analytics process may be enhanced by machine learning and supervised discretization. The supervised discretization helps address a business question requiring predictions. A user may create and compare predictive models to find the best one to bring the best predictions to address the business question. Each predictive model produces intuitive visualizations of the results, making it easy to interpret its findings.

FIG. 9 is a block diagram illustrating an example of a computer-implemented System 900 used to provide computational functionalities associated with described algorithms, methods, functions, processes, flows, and procedures, according to an implementation of the present disclosure. In the illustrated implementation, System 900 includes a Computer 902 and a Network 930.

The illustrated Computer 902 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 902 can include an input device, such as a keypad, keyboard, or touch screen, or a combination of input devices that can accept user information, and an output device that conveys information associated with the operation of the Computer 902, including digital data, visual, audio, another type of information, or a combination of types of information, on a graphical-type user interface (UI) (or GUI) or other UI.

The Computer 902 can serve in a role in a distributed computing system as, for example, a client, network component, a server, or a database or another persistency, or a combination of roles for performing the subject matter described in the present disclosure. The illustrated Computer 902 is communicably coupled with a Network 930. In some implementations, one or more components of the Computer 902 can be configured to operate within an environment, or a combination of environments, including cloud-computing, local, or global.

At a high level, the Computer 902 is an electronic computing device operable to receive, transmit, process, store, or manage data and information associated with the described subject matter. According to some implementations, the Computer 902 can also include or be communicably coupled with a server, such as an application server, e-mail server, web server, caching server, or streaming data server, or a combination of servers.

The Computer 902 can receive requests over Network 930 (for example, from a client software application executing on another Computer 902) and respond to the received requests by processing the received requests using a software application or a combination of software applications. In addition, requests can also be sent to the Computer 902 from internal users (for example, from a command console or by another internal access method), external or third-parties, or other entities, individuals, systems, or computers.

Each of the components of the Computer 902 can communicate using a System Bus 903. In some implementations, any or all of the components of the Computer 902, including hardware, software, or a combination of hardware and software, can interface over the System Bus 903 using an application programming interface (API) 912, a Service Layer 913, or a combination of the API 912 and Service Layer 913. The API 912 can include specifications for routines, data structures, and object classes. The API 912 can be either computer-language independent or dependent and refer to a complete interface, a single function, or even a set of APIs. The Service Layer 913 provides software services to the Computer 902 or other components (whether illustrated or not) that are communicably coupled to the Computer 902. The functionality of the Computer 902 can be accessible for all service consumers using the Service Layer 913. Software services, such as those provided by the Service Layer 913, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 902, alternative implementations can illustrate the API 912 or the Service Layer 913 as stand-alone components in relation to other components of the Computer 902 or other components (whether illustrated or not) that are communicably coupled to the Computer 902. Moreover, any or all parts of the API 912 or the Service Layer 913 can be implemented as a child or a sub-module of another software module, enterprise application, or hardware module without departing from the scope of the present disclosure.

The Computer 902 includes an Interface 904. Although illustrated as a single Interface 904, two or more Interfaces 904 can be used according to particular needs, desires, or particular implementations of the Computer 902. The Interface 904 is used by the Computer 902 for communicating with another computing system (whether illustrated or not) that is communicatively linked to the Network 930 in a distributed environment. Generally, the Interface 904 is operable to communicate with the Network 930 and includes logic encoded in software, hardware, or a combination of software and hardware. More specifically, the Interface 904 can include software supporting one or more communication protocols associated with communications such that the Network 930 or hardware of Interface 904 is operable to communicate physical signals within and outside of the illustrated Computer 902.

The Computer 902 includes a Processor 905. Although illustrated as a single Processor 905, two or more Processors 905 can be used according to particular needs, desires, or particular implementations of the Computer 902. Generally, the Processor 905 executes instructions and manipulates data to perform the operations of the Computer 902 and any algorithms, methods, functions, processes, flows, and procedures as described in the present disclosure.

The Computer 902 also includes a Database 906 that can hold data for the Computer 902, another component communicatively linked to the Network 930 (whether illustrated or not), or a combination of the Computer 902 and another component. For example, Database 906 can be an in-memory or conventional database storing data consistent with the present disclosure. In some implementations, Database 906 can be a combination of two or more different database types (for example, a hybrid in-memory and conventional database) according to particular needs, desires, or particular implementations of the Computer 902 and the described functionality. Although illustrated as a single Database 906, two or more databases of similar or differing types can be used according to particular needs, desires, or particular implementations of the Computer 902 and the described functionality. While Database 906 is illustrated as an integral component of the Computer 902, in alternative implementations, Database 906 can be external to the Computer 902. The Database 906 can hold and operate on at least any data type mentioned or any data type consistent with this disclosure.

The Computer 902 also includes a Memory 907 that can hold data for the Computer 902, another component or components communicatively linked to the Network 930 (whether illustrated or not), or a combination of the Computer 902 and another component. Memory 907 can store any data consistent with the present disclosure. In some implementations, Memory 907 can be a combination of two or more different types of memory (for example, a combination of semiconductor and magnetic storage) according to particular needs, desires, or particular implementations of the Computer 902 and the described functionality. Although illustrated as a single Memory 907, two or more Memories 907 or similar or differing types can be used according to particular needs, desires, or particular implementations of the Computer 902 and the described functionality. While Memory 907 is illustrated as an integral component of the Computer 902, in alternative implementations, Memory 907 can be external to the Computer 902.

The Application 908 is an algorithmic software engine providing functionality according to particular needs, desires, or particular implementations of the Computer 902, particularly with respect to functionality described in the present disclosure. For example, Application 908 can serve as one or more components, modules, or applications. Further, although illustrated as a single Application 908, the Application 908 can be implemented as multiple Applications 908 on the Computer 902. In addition, although illustrated as integral to the Computer 902, in alternative implementations, the Application 908 can be external to the Computer 902.

The Computer 902 can also include a Power Supply 914. The Power Supply 914 can include a rechargeable or non-rechargeable battery that can be configured to be either user- or non-user-replaceable. In some implementations, the Power Supply 914 can include power-conversion or management circuits (including recharging, standby, or another power management functionality). In some implementations, the Power Supply 914 can include a power plug to allow the Computer 902 to be plugged into a wall socket or another power source to, for example, power the Computer 902 or recharge a rechargeable battery.

There can be any number of Computers 902 associated with, or external to, a computer system containing Computer 902, each Computer 902 communicating over Network 930. Further, the term “client,” “user,” or other appropriate terminology can be used interchangeably, as appropriate, without departing from the scope of the present disclosure. Moreover, the present disclosure contemplates that many users can use one Computer 902, or that one user can use multiple computers 902.

Described implementations of the subject matter can include one or more features, alone or in combination.

For example, in a first implementation, a computer-implemented method, comprising: receiving a plurality of inputs corresponding to a plurality of instances, wherein each input of the plurality of inputs representing multiple attributes of a respective instance; training, using the plurality of inputs and as a trained supervised and multivariate machine learning model, a supervised and multivariate machine learning model; determining multiple split point lists based on the trained supervised and multivariate machine learning model, wherein the multiple split point lists correspond to the multiple attributes, and wherein each of the multiple split point lists comprises a number of split points and a number of split gains associated with a respective attribute; for each attribute of the multiple attributes, determining a cut point list by clustering the split point list associated with the attribute based on the number of split points and the number of split gains comprised in the split point list, wherein the cut point list comprises a number of cut points dividing the attribute into one or more intervals; and dividing the plurality of instances into one or more groups based on the plurality of inputs and the one or more intervals.

The foregoing and other described implementations can each, optionally, include one or more of the following features:

A first feature, combinable with any of the following features, wherein each of the plurality of inputs comprises multiple values, and wherein each of the multiple values representing one of the multiple attributes of the respective instance.

A second feature, combinable with any of the previous or following features, wherein the supervised and multivariate machine learning model is a Gradient Tree Boosting (GTB) model.

A third feature, combinable with any of the previous or following features, wherein a first split point list of the multiple split point lists comprises one or more split points and one or more split gains.

A fourth feature, combinable with any of the previous or following features, wherein a quantity of the one or more split points is less than a predetermined cut point number, and wherein determining a first cut point list by clustering the first split point list comprises: determining the one or more split points as a number of cut points comprised in the first cut point list.

A fifth feature, combinable with any of the previous or following features, wherein a quantity of the one or more split points is more than a predetermined cut point number, and wherein determining a first cut point list by clustering the first split point list comprises: applying a weighted clustering algorithm to the one or more split points using the one or more split gains as weights for the weighted clustering algorithm; and determining a number of cut points comprised in the first cut point list based on the weighted clustering algorithm, the one or more split points, and the one or more split gains.

A sixth feature, combinable with any of the previous or following features, wherein the weighted clustering algorithm is a weighted k-medians clustering algorithm.

A seventh feature, combinable with any of the previous or following features, wherein a second split point list of the multiple split point lists is empty, and wherein determining a second cut point list by clustering the second split point list comprises: determining the second cut point list as an empty list, wherein an attribute corresponding to the second split point list is uninformative and is compressed into one single interval.

An eighth feature, combinable with any of the previous or following features, further comprising: providing the plurality of instances, the multiple attributes, and the one or more groups as inputs to a knowledge discovery application.

A ninth feature, combinable with any of the previous or following features, providing the plurality of instances, the multiple attributes, and the one or more groups to a data analysis application to create a predictive model.

In a second implementation, a non-transitory, computer-readable medium storing one or more instructions executable by a computer system to perform one or more operations, comprising: receiving a plurality of inputs corresponding to a plurality of instances, wherein each input of the plurality of inputs representing multiple attributes of a respective instance; training, using the plurality of inputs and as a trained supervised and multivariate machine learning model, a supervised and multivariate machine learning model; determining multiple split point lists based on the trained supervised and multivariate machine learning model, wherein the multiple split point lists correspond to the multiple attributes, and wherein each of the multiple split point lists comprises a number of split points and a number of split gains associated with a respective attribute; for each attribute of the multiple attributes, determining a cut point list by clustering the split point list associated with the attribute based on the number of split points and the number of split gains comprised in the split point list, wherein the cut point list comprises a number of cut points dividing the attribute into one or more intervals; and dividing the plurality of instances into one or more groups based on the plurality of inputs and the one or more intervals.

The foregoing and other described implementations can each, optionally, include one or more of the following features:

A first feature, combinable with any of the following features, wherein each of the plurality of inputs comprises multiple values, and wherein each of the multiple values representing one of the multiple attributes of the respective instance.

A second feature, combinable with any of the previous or following features, wherein the supervised and multivariate machine learning model is a Gradient Tree Boosting (GTB) model.

A third feature, combinable with any of the previous or following features, wherein a first split point list of the multiple split point lists comprises one or more split points and one or more split gains.

A fourth feature, combinable with any of the previous or following features, wherein a quantity of the one or more split points is less than a predetermined cut point number, and wherein determining a first cut point list by clustering the first split point list comprises: determining the one or more split points as a number of cut points comprised in the first cut point list.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: receiving a plurality of inputs corresponding to a plurality of instances, wherein each input of the plurality of inputs representing multiple attributes of a respective instance; training, using the plurality of inputs and as a trained supervised and multivariate machine learning model, a supervised and multivariate machine learning model; determining multiple split point lists based on the trained supervised and multivariate machine learning model, wherein the multiple split point lists correspond to the multiple attributes, and wherein each of the multiple split point lists comprises a number of split points and a number of split gains associated with a respective attribute; for each attribute of the multiple attributes, determining a cut point list by clustering the split point list associated with the attribute based on the number of split points and the number of split gains comprised in the split point list, wherein the cut point list comprises a number of cut points dividing the attribute into one or more intervals; and dividing the plurality of instances into one or more groups based on the plurality of inputs and the one or more intervals.

The foregoing and other described implementations can each, optionally, include one or more of the following features:

A first feature, combinable with any of the following features, wherein each of the plurality of inputs comprises multiple values, and wherein each of the multiple values representing one of the multiple attributes of the respective instance.

A second feature, combinable with any of the previous or following features, wherein the supervised and multivariate machine learning model is a Gradient Tree Boosting (GTB) model.

A third feature, combinable with any of the previous or following features, wherein a first split point list of the multiple split point lists comprises one or more split points and one or more split gains.

A fourth feature, combinable with any of the previous or following features, wherein a quantity of the one or more split points is less than a predetermined cut point number, and wherein determining a first cut point list by clustering the first split point list comprises: determining the one or more split points as a number of cut points comprised in the first cut point list.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus.” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R. DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving a plurality of inputs corresponding to a plurality of instances, wherein each input of the plurality of inputs representing multiple attributes of a respective instance;
training, using the plurality of inputs and as a trained supervised and multivariate machine learning model, a supervised and multivariate machine learning model;
determining multiple split point lists based on the trained supervised and multivariate machine learning model, wherein the multiple split point lists correspond to the multiple attributes, and wherein each of the multiple split point lists comprises a number of split points and a number of split gains associated with a respective attribute;
for each attribute of the multiple attributes, determining a cut point list by clustering the split point list associated with the attribute based on the number of split points and the number of split gains comprised in the split point list, wherein the cut point list comprises a number of cut points dividing the attribute into one or more intervals; and
dividing the plurality of instances into one or more groups based on the plurality of inputs and the one or more intervals.

2. The computer-implemented method of claim 1, wherein each of the plurality of inputs comprises multiple values, and wherein each of the multiple values representing one of the multiple attributes of the respective instance.

3. The computer-implemented method of claim 1, wherein the supervised and multivariate machine learning model is a Gradient Tree Boosting (GTB) model.

4. The computer-implemented method of claim 1, wherein a first split point list of the multiple split point lists comprises one or more split points and one or more split gains.

5. The computer-implemented method of claim 4, wherein a quantity of the one or more split points is less than a predetermined cut point number, and wherein determining a first cut point list by clustering the first split point list comprises:
determining the one or more split points as a number of cut points comprised in the first cut point list.

6. The computer-implemented method of claim 4, wherein a quantity of the one or more split points is more than a predetermined cut point number, and wherein determining a first cut point list by clustering the first split point list comprises:
applying a weighted clustering algorithm to the one or more split points using the one or more split gains as weights for the weighted clustering algorithm; and
determining a number of cut points comprised in the first cut point list based on the weighted clustering algorithm, the one or more split points, and the one or more split gains.

7. The computer-implemented method of claim 6, wherein the weighted clustering algorithm is a weighted k-medians clustering algorithm.

8. The computer-implemented method of claim 1, wherein a second split point list of the multiple split point lists is empty, and wherein determining a second cut point list by clustering the second split point list comprises:
determining the second cut point list as an empty list, wherein an attribute corresponding to the second split point list is uninformative and is compressed into one single interval.

9. The computer-implemented method of claim 1, further comprising:
providing the plurality of instances, the multiple attributes, and the one or more groups as inputs to a knowledge discovery application.

10. The computer-implemented method of claim 1, further comprising:
providing the plurality of instances, the multiple attributes, and the one or more groups to a data analysis application to create a predictive model.

11. A non-transitory, computer-readable medium storing one or more instructions executable by a computer system to perform one or more operations, comprising:
receiving a plurality of inputs corresponding to a plurality of instances, wherein each input of the plurality of inputs representing multiple attributes of a respective instance;
training, using the plurality of inputs and as a trained supervised and multivariate machine learning model, a supervised and multivariate machine learning model;
determining multiple split point lists based on the trained supervised and multivariate machine learning model, wherein the multiple split point lists correspond to the multiple attributes, and wherein each of the multiple split point lists comprises a number of split points and a number of split gains associated with a respective attribute;
for each attribute of the multiple attributes, determining a cut point list by clustering the split point list associated with the attribute based on the number of split points and the number of split gains comprised in the split point list, wherein the cut point list comprises a number of cut points dividing the attribute into one or more intervals; and
dividing the plurality of instances into one or more groups based on the plurality of inputs and the one or more intervals.

12. The non-transitory, computer readable medium of claim 11, wherein each of the plurality of inputs comprises multiple values, and wherein each of the multiple values representing one of the multiple attributes of the respective instance.

13. The non-transitory, computer readable medium of claim 11, wherein the supervised and multivariate machine learning model is a Gradient Tree Boosting (GTB) model.

14. The non-transitory, computer readable medium of claim 11, wherein a first split point list of the multiple split point lists comprises one or more split points and one or more split gains.

15. The non-transitory, computer readable medium of claim 14, wherein a quantity of the one or more split points is less than a predetermined cut point number, and wherein determining a first cut point list by clustering the first split point list comprises:
determining the one or more split points as a number of cut points comprised in the first cut point list.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving a plurality of inputs corresponding to a plurality of instances, wherein each input of the plurality of inputs representing multiple attributes of a respective instance;
training, using the plurality of inputs and as a trained supervised and multivariate machine learning model, a supervised and multivariate machine learning model;
determining multiple split point lists based on the trained supervised and multivariate machine learning model, wherein the multiple split point lists correspond to the multiple attributes, and wherein each of the multiple split point lists comprises a number of split points and a number of split gains associated with a respective attribute;
for each attribute of the multiple attributes, determining a cut point list by clustering the split point list associated with the attribute based on the number of split points and the number of split gains comprised in the split point list, wherein the cut point list comprises a number of cut points dividing the attribute into one or more intervals; and
dividing the plurality of instances into one or more groups based on the plurality of inputs and the one or more intervals.

17. The computer-implemented system of claim 16, wherein each of the plurality of inputs comprises multiple values, and wherein each of the multiple values representing one of the multiple attributes of the respective instance.

18. The computer-implemented system of claim 16, wherein the supervised and multivariate machine learning model is a Gradient Tree Boosting (GTB) model.

19. The computer-implemented system of claim 16, wherein a first split point list of the multiple split point lists comprises one or more split points and one or more split gains.

20. The computer-implemented system of claim 19, wherein a quantity of the one or more split points is less than a predetermined cut point number, and wherein determining a first cut point list by clustering the first split point list comprises:
determining the one or more split points as a number of cut points comprised in the first cut point list.
